(19) United States
(12) Patent Application Publication
(10) Pub. No.: US 2016/0306420 A1
(43) Pub. Date: Oct. 20, 2016

(54) Method for Controlling a Surgical Camera through Natural Head Movements

(71) Applicant: Charles Arthur Hill, III, Charlotte, NC (US)

(72) Inventor: Charles Arthur Hill, III, Charlotte, NC (US)

(21) Appl. No.: 15/068,873

(22) Filed: Mar. 14, 2016

Related U.S. Application Data
(60) Provisional application No. 62/149,255, filed on Apr. 17, 2015.

(51) Int. Cl. G06F 3/01; H04N 5/232

(52) U.S. Cl. CPC G06F 3/012; H04N 5/23296

(57) ABSTRACT

A method for controlling a surgical camera through head movements enables a user's head movements to be captured through a plurality of motion-capture sensors positioned on a wearable headpiece. A live video feed from the surgical camera is output to a left digital display and a right digital display on the wearable headpiece. The head movements are translated into corresponding directional camera movements and the surgical camera is moved according to the directional camera movements. The surgical camera may be moved via an actuator that is mechanically coupled to the surgical camera. The capture of head movements and the movement of the surgical camera may be temporarily disabled by various means including a gaze detection device, a microphone, and a manual disable switch.

The current application claims a priority to the U.S. Provisional Patent application Ser. No. 62/149,255 filed on Apr. 17, 2015.

### FIELD OF THE INVENTION

The present invention relates generally to a method for intuitively controlling the movements of a camera during a surgical procedure. More specifically, the present invention is a method for controlling a surgical camera through natural head movements.

### BACKGROUND OF THE INVENTION

When performing minimally invasive surgical procedures, it is common to utilize a camera to examine the interior of a body cavity. A drawback of utilizing a camera during a surgical procedure is the inability of a single surgeon to operate the camera simultaneously with two surgical instruments or (robotic) effector arms. Because of this limitation, an assistant must be present in order to operate the camera during the course of the surgical procedure. This can be a frustrating and inefficient experience, particularly if the camera operator is inexperienced. In certain cases, an inexperienced camera operator can lengthen operation times and even possibly jeopardize patient safety during the surgical procedure.

Because of the drawbacks of having a separate camera operator during a surgical procedure, a means for a surgeon to accurately and responsively control a surgical camera is generally desired. Body-mounted control devices enable the surgeon to utilize his or her hands freely during the course of a surgical procedure. Current devices include head-mounted control devices that translate the surgeon's head movements into camera movements. However, current relevant technology in head-mounted control devices is somewhat limited for various reasons. One such limitation is the fact that a camera's view may only be adjusted incrementally. This is impractical and inefficient as a “large” adjustment to the camera's view requires a large number of “small” incremental movements. In addition, current control devices are generally limited in the amount of movement of which the associated cameras are capable. The present invention seeks to address the aforementioned issues as well as provide a solution for a surgeon to freely utilize his or her hands while simultaneously controlling the movements of a camera to view the interior of a body cavity.

The present invention is a method for controlling a surgical camera through natural head movements. The present invention provides a hands-free means for the surgeon to control a surgical camera, enabling the user to continue operating on a patient without pausing to adjust the view of the surgical camera. Movement of the surgical camera is halted if it is detected that the user is not looking directly at the live video feed that is output by the surgical camera. Alternatively, the movement of the surgical camera may be halted manually by the user via a switch, a vocal command, or a similar means of deactivating the movement of the surgical camera.

In solving the aforementioned problems, additional problems were encountered. To provide more natural and intuitive head control, the display was moved from a free-standing or boom-mounted monitor to a wearable headpiece. Existing technology obstructs the user's view from anything other than the display. In addition, head tracking alone creates the problem of potentially unintended movements of the camera when the head moves. A solution to these two problems is also presented. The lower field of view remains unobstructed by the headpiece so that movement within the OR and visualization of instruments or controls remains uninhibited. Gaze detection determines whether the user is looking at the display or away from the display. Movement of the surgical camera is halted if it is detected that the user is not looking directly at the live video feed that is output by the surgical camera. Alternatively, the movement of the surgical camera may be halted manually by the user via a switch, a vocal command, or a similar means of deactivating the movement of the surgical camera. The present invention also allows a surgeon to remain at the sterile surgical field if necessary.

### BRIEF DESCRIPTION OF THE DRAWINGS

FIG. 1A is a portion of the flowchart illustrating the overall process that is followed by the present invention.

FIG. 1B is a continuation of the flowchart illustrating the overall process that is followed by the present invention.

FIG. 2 is a flowchart illustrating a secondary process that is followed by the present invention.

FIG. 3 is a flowchart illustrating a secondary process that is followed by the present invention.

FIG. 4 is a flowchart illustrating a secondary process that is followed by the present invention.

FIG. 5 is a flowchart illustrating a secondary process that is followed by the present invention.

FIG. 6 is a flowchart illustrating a secondary process that is followed by the present invention.

FIG. 7 is a flowchart illustrating a secondary process that is followed by the present invention.

FIG. 8 is a flowchart illustrating a secondary process that is followed by the present invention.

FIG. 9 is a flowchart illustrating a secondary process that is followed by the present invention.

FIG. 10 is a diagram depicting the positioning of the plurality of LEDs, the gaze detection device, and the bottom peripheral edge.

FIG. 11 is a diagram depicting the positioning of the gaze detection device and the perimetric border.

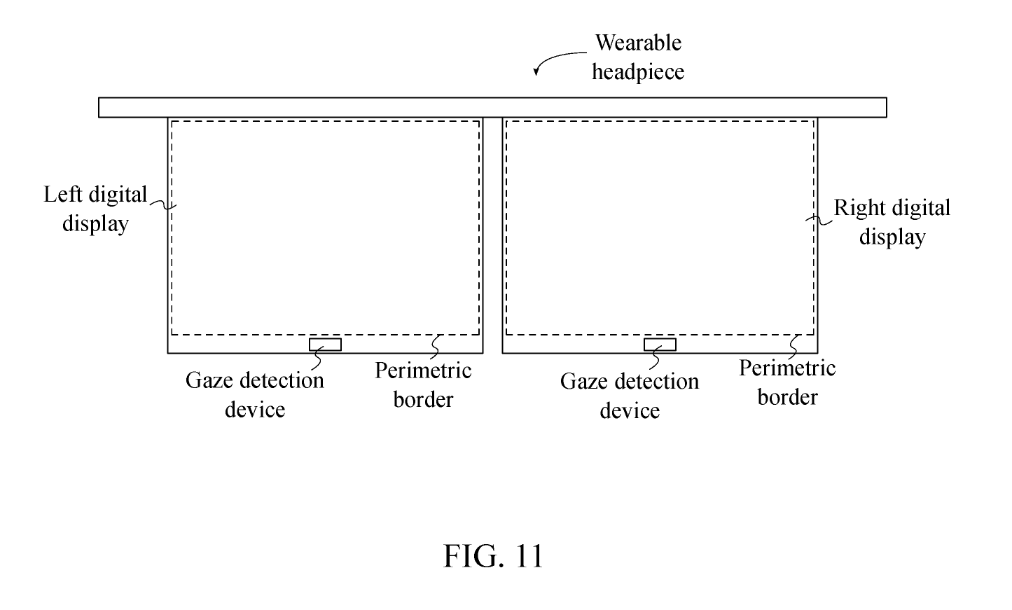

### DETAIL DESCRIPTIONS OF THE INVENTION

All illustrations of the drawings are for the purpose of describing selected versions of the present invention and are not intended to limit the scope of the present invention.

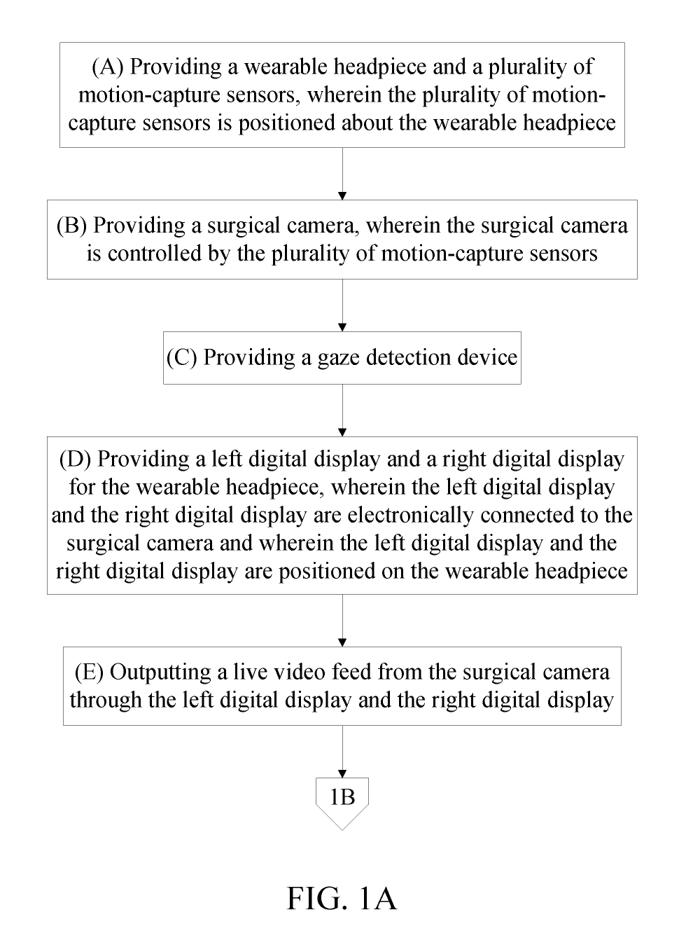

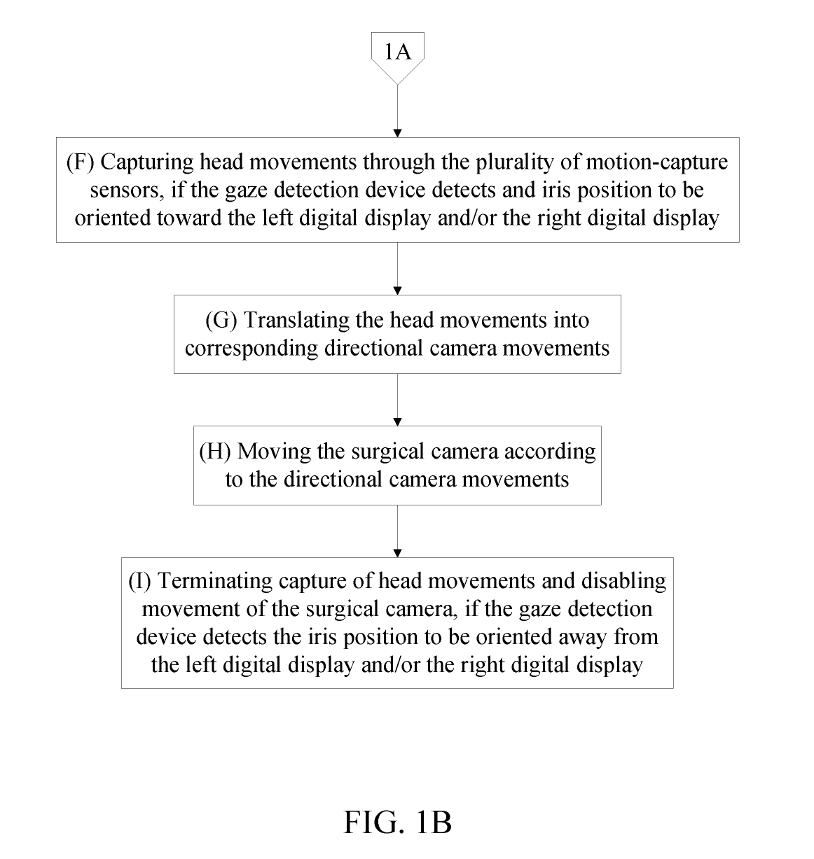

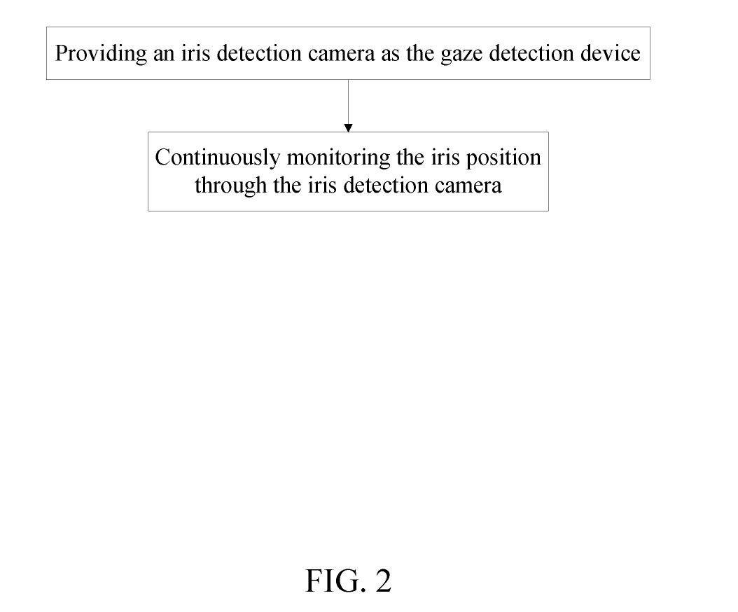

The present invention is a method for controlling a surgical camera through natural head movements. The overall process followed by the present invention is shown in FIG. 1A and FIG. 1B while secondary processes followed by the present invention are shown in FIGS. 2-9. The present invention may be utilized in a range of medical procedures including, but not limited to, laparoscopy and endoscopy. The object of the present invention is to provide the user with a means of controlling a surgical camera through head movements while leaving his or her hands free during a medical procedure.

With reference to FIG. 1, in the preferred embodiment of the present invention, a user such as a surgeon who is performing a procedure on a patient utilizes a wearable headpiece in order to control a surgical camera. A plurality of motion-capture sensors is utilized to track the movement of the wearable headpiece and, by extension, the user's head. The plurality of motion-capture sensors may include, but are not limited to, accelerometers and gyroscopes. As such, the plurality of motion-capture sensors is able to detect the magnitude and direction of proper acceleration experienced by the user's head during movement. Additionally, the orientation and rotation of the user's head are detected through the plurality of motion-capture sensors as well.

The surgical camera is controlled by the plurality of motion-capture sensors, enabling the user to move his or her head in order to correspondingly move the surgical camera. The wearable headpiece preferably includes a left digital display and a right digital display that are electronically connected to the surgical camera. The left digital display and the right digital display are positioned on the wearable headpiece, enabling the user to easily view the left digital display and the right digital display. The left digital display and the right digital display are able to receive separate inputs in order to recreate three-dimensional viewing from compatible cameras. In the preferred embodiment of the present invention, the left digital display and the right digital display are positioned on the wearable headpiece in a manner such that the user is able to direct his or her view in a downward direction without his or her view being obstructed. This is necessary due to the fact that during the course of a surgical procedure, the user is required to alternate between viewing the live video feed on the left digital display and the right digital display and viewing the patient. As such, in the preferred embodiment of the present invention, the left digital display and the right digital display only obstruct approximately one-half to two-thirds of the user's field of view.

A live video feed from the surgical camera is outputted to the left digital display and the right digital display. The surgical camera is thus able to provide the user with a view of the area of the patient's body in which the surgical camera is in operation. Head movements are captured through the plurality of motion-capture sensors. In the preferred embodiment of the present invention, the plurality of motion-capture sensors is distributed about the wearable headpiece in order to more accurately capture the movement of the user's head. The head movements are translated into corresponding directional camera movements in order to enable the head movements to be utilized to move the surgical camera at the direction of the user. The surgical camera is then moved according to the directional camera movements, allowing the surgical camera to navigate based on the captured head movements. In the preferred embodiment of the present invention, movement of the surgical camera is continuous rather than incremental and as such, movement of the surgical camera as experienced by the user is fluid and natural. The present invention may be utilized in conjunction with a clutch or similar mechanism for centering his or her head as the field of view provided by the surgical camera is adjusted out of a comfortable ergonomic position.

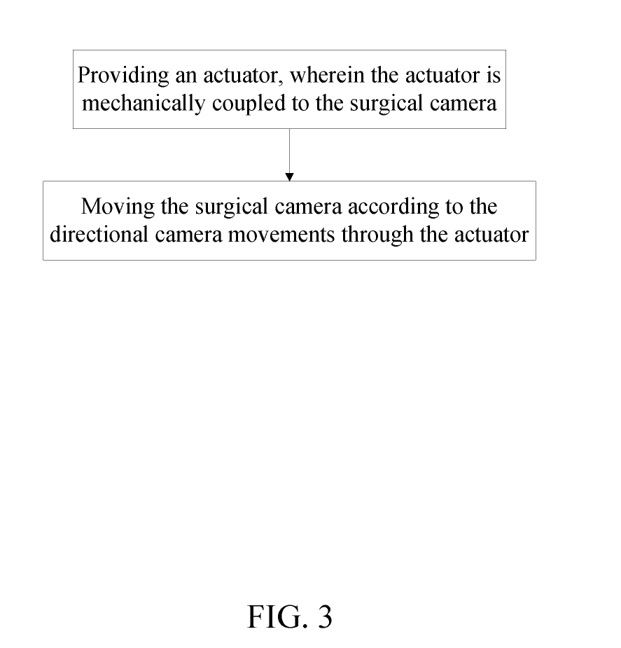

Because precise movements are required to navigate a surgical camera during the course of a surgical procedure, it is important that the user does not unintentionally move the surgical camera. As such, the present invention includes several means of disabling the tracking of head movements in order to prevent unintended movement of the surgical camera. With reference to FIG. 2 and FIG. 3, a gaze detection device may be utilized to disable the movement of the surgical camera. In the preferred embodiment of the present invention, the gaze detection device is a device such as an iris detection camera that is capable of determining if the user's view is directed at the left digital display and the right digital display. The gaze detection device is oriented toward the user's eyes. An iris position of the user is continuously monitored through the iris detection camera. If the gaze detection device detects the iris position to be oriented toward the left digital display and/or the right digital display, head movements are captured through the plurality of motion-capture sensors. This ensures that the surgical camera is able to move according to the head movements while the user's view is directed toward the left digital display and the right digital display. If the gaze detection device detects the iris position to be oriented away from the left digital display and/or the right digital display, capture of head movements is terminated and movement of the surgical camera is disabled. This also causes the left digital display and the right digital display to immediately turn off as an indicator to the user that capture of head movements is deactivated. Additional confirmation of deactivation such as an audible tone generated by a speaker within the wearable headpiece may be present as well. As a result, if the user desires to disable movement of the surgical camera, he or she may simply look away from the left digital display and the right digital display in order to disable capture of head movements.

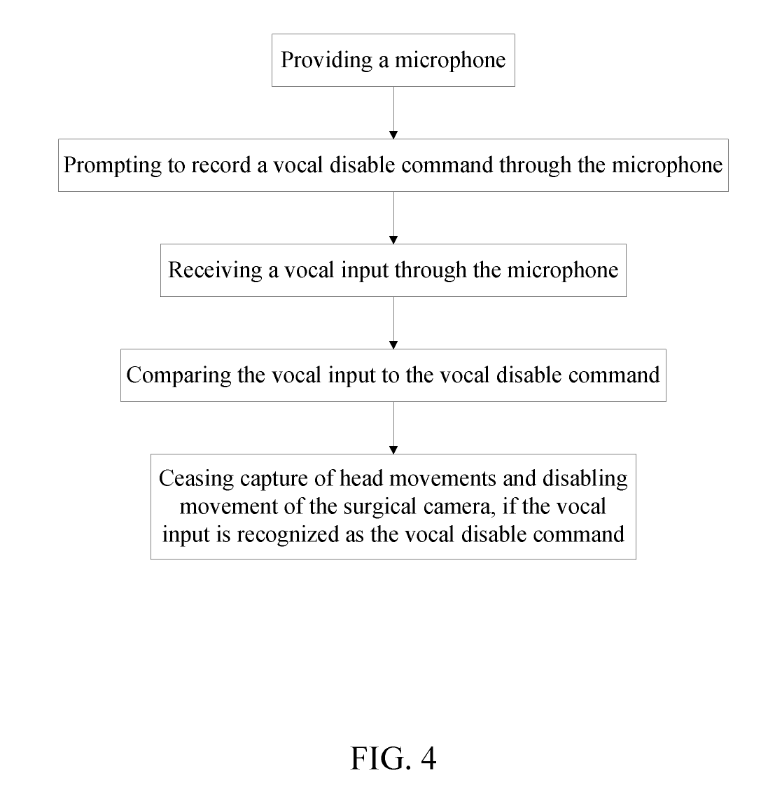

With reference to FIG. 4, in the preferred embodiment of the present invention, the surgical camera may be moved by an actuator such as, but not limited to, a robotic arm. The actuator is mechanically coupled to the surgical camera to allow the actuator to direct the movement of the surgical camera. The surgical camera is moved according to the directional camera movements through the actuator. As such, the plurality of motion-capture sensors is able to communicate with the actuator in order to ensure that the directional camera movements are relayed to the actuator and executed accordingly to move the surgical camera.

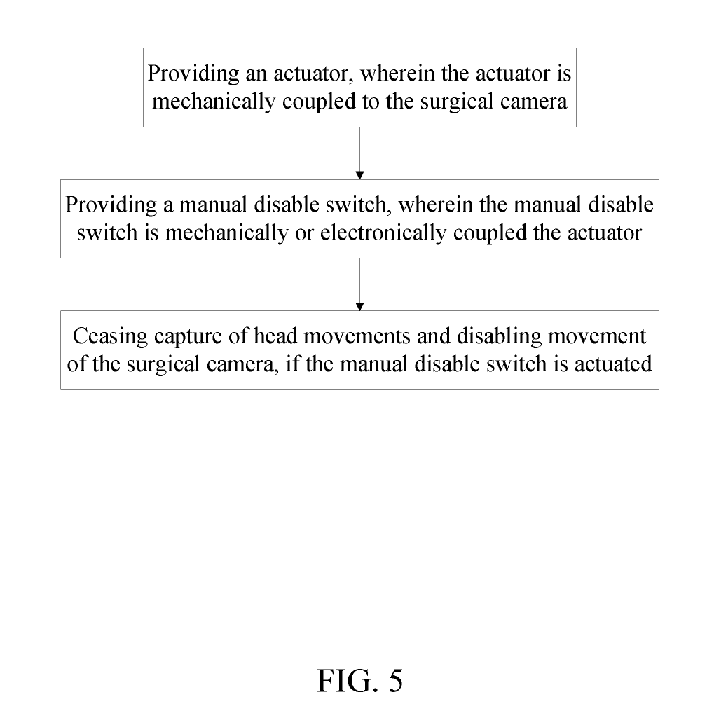

As shown in FIG. 5, in addition to the gaze detection device, a microphone may be utilized to verbally disable movement of the surgical camera. In this example, the user is prompted to record a vocal disable command through the microphone. The vocal disable command may be utilized in conjunction with or in lieu of the gaze detection device in order to disable movement of the surgical camera. The vocal input is recorded through the microphone and may be saved onto a storage device that is integrated with or separate from the wearable headpiece. During use of the present invention, a vocal input from the user is received through the microphone when the user wishes to verbally disable movement of the surgical camera. The vocal input is compared to the vocal disable command in order to determine if the vocal input from the user matches the vocal disable command. If the vocal input is recognized as the vocal disable command, capture of head movements is ceased and movement of the surgical camera is disabled. The microphone may thus be utilized in a similar manner as the gaze detection device in order to disable movement of the surgical camera at the user's direction.

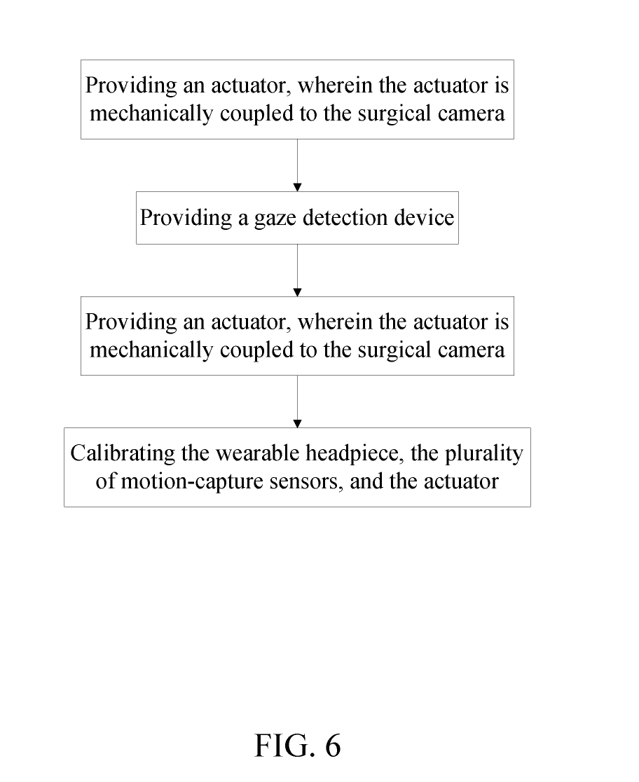

With reference to FIG. 6, a manual disable switch may be utilized to disable movement of the surgical camera as well. The manual disable switch may be utilized in conjunction with or in lieu of the gaze detection device and/or the microphone in order to disable movement of the surgical camera. The manual disable switch is mechanically or electronically coupled to the actuator, allowing movement of the surgical camera to immediately be disabled upon actuation of the manual disable switch. If the manual disable switch is actuated, capture of head movements is ceased and movement of the surgical camera is disabled. The manual disable switch thus provides a third means of disabling movement of the surgical camera in order to avoid unintended movement of the surgical camera. The manual disable switch may be actuated in various ways including, but not limited to, with the user's hands and with the user's feet.

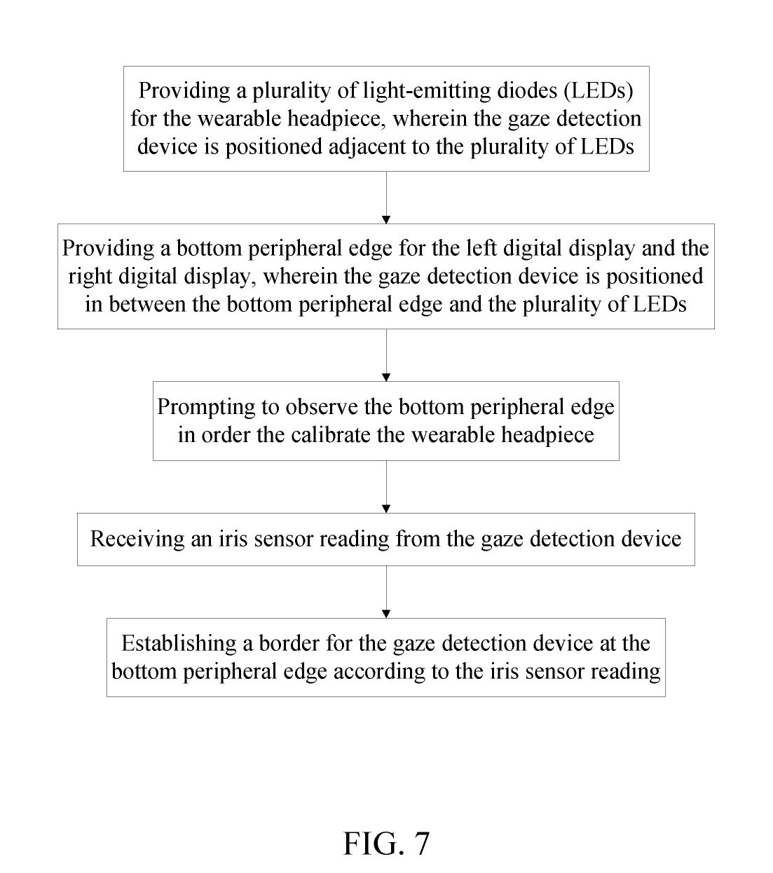

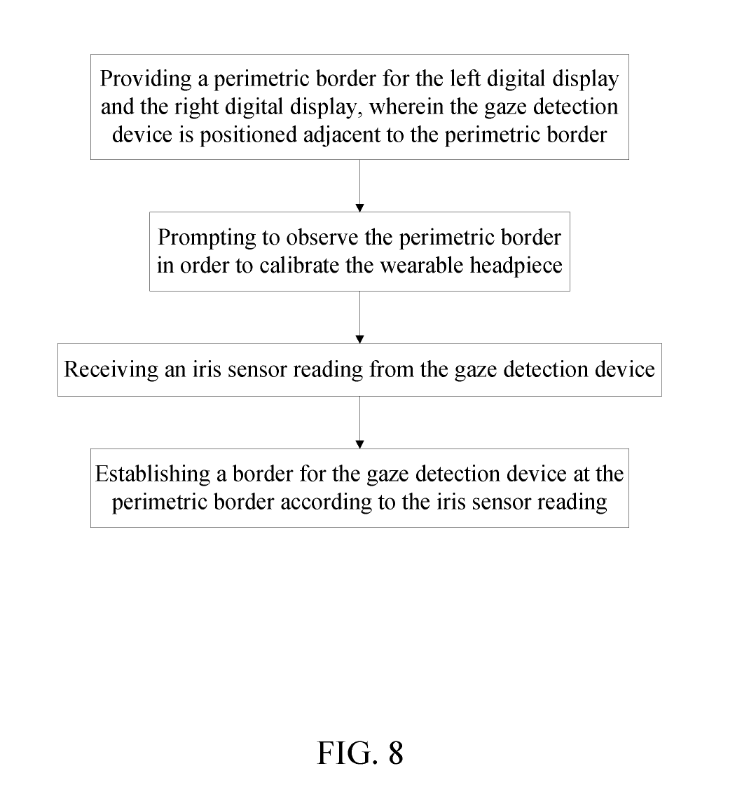

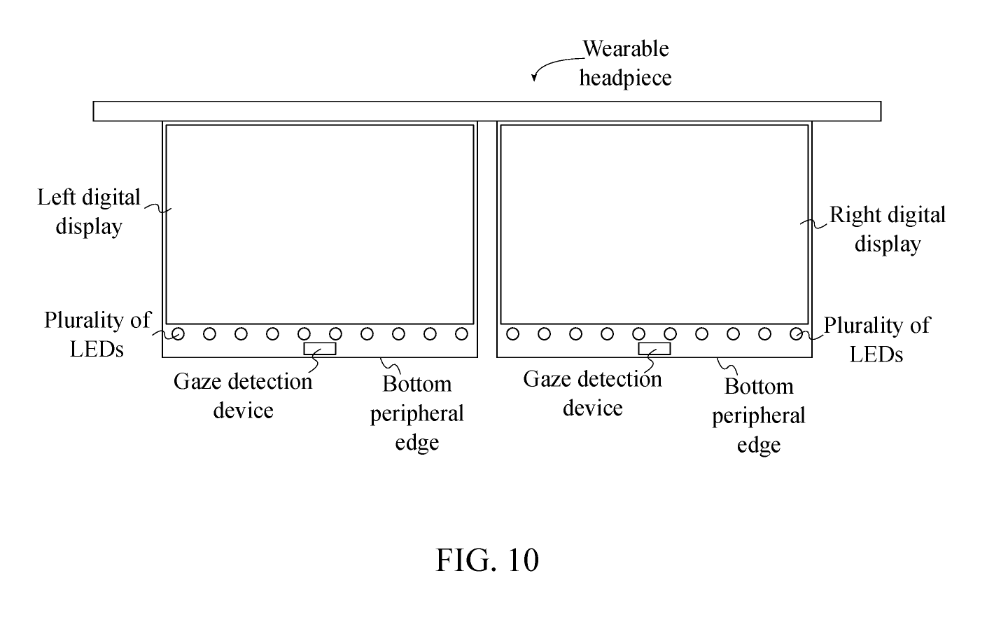

The wearable headpiece, the plurality of motion-capture sensors, and the actuator may be calibrated to the user's preferences prior to use as shown in FIG. 7. In the preferred embodiment of the present invention, the wearable headpiece may be calibrated in order to establish a threshold for the gaze detection device as shown in FIG. 8 and FIG. 10. The user is able to determine the threshold at which movement of the surgical camera is disabled when the iris position of the user is oriented away from the left digital display and the right digital display. A plurality of light-emitting diodes (LEDs) is utilized for the wearable headpiece when calibrating the wearable headpiece. The gaze detection device is positioned adjacent to the plurality of LEDs. The user is thus able to look at the plurality of LEDs with his or her gaze monitored by the gaze detection device as the gaze detection device and the plurality of LEDs are in close proximity to each other. A bottom peripheral edge is present for the left digital display and the right digital display. The bottom peripheral edge is the edge of the portion of the wearable device that is in front of the user's face when the wearable device is worn. The gaze detection device is positioned in between the bottom peripheral edge and the plurality of LEDs. The plurality of LEDs serves as a visual cue for the user when calibrating the wearable headpiece. More specifically, the plurality of LEDs is utilized to guide the user's gaze when calibrating the wearable headpiece. The user is prompted to observe the bottom peripheral edge in order to calibrate the wearable headpiece. Because the gaze detection device is positioned in between the bottom peripheral edge and the plurality of LEDs, the user's gaze passes the gaze detection device when directing his or her gaze from the plurality of LEDs to the bottom peripheral edge. As the user observes the bottom peripheral edge, an iris sensor reading is received from the gaze detection device in order to continuously monitor the movement of the user's iris position. A border is established for the gaze detection device at the bottom peripheral edge according to the iris sensor reading. This enables the border for the gaze detection device to be established based on the unique shape and size of the user's head in order to ensure that the wearable headpiece is calibrated specifically for the user.

A perimetric border for the left digital display and the right digital display may be utilized to calibrate the wearable headpiece. The perimetric border may be delineated by the outermost pixels of the left digital display and the right digital display. As such, when these outermost pixels are activated, the perimetric border appears as a rectangular outline of the left digital display and the right digital display. The gaze detection device is positioned adjacent to the perimetric border and is able to detect if the user's gaze is directed within the perimetric border or outside of the perimetric border. The user is prompted to observe the perimetric border in order to calibrate the wearable headpiece. The gaze detection device is able to detect the user's gaze when the user's gaze is directed toward the left edge, the right edge, the top edge, or the bottom edge of the perimetric border. As such, the gaze detection device is able to detect if the user's gaze passes from within the perimetric border to outside of the perimetric border and vice versa. As the user observes the perimetric border, an iris sensor reading is received from the gaze detection device in order to continuously monitor the movement of the user's iris position. A border is established for the gaze detection device at the perimetric border according to the iris sensor reading. As with the plurality of LEDs and the bottom peripheral edge, this allows the border for the gaze detection device to be established based on the unique shape and size of the user's head.

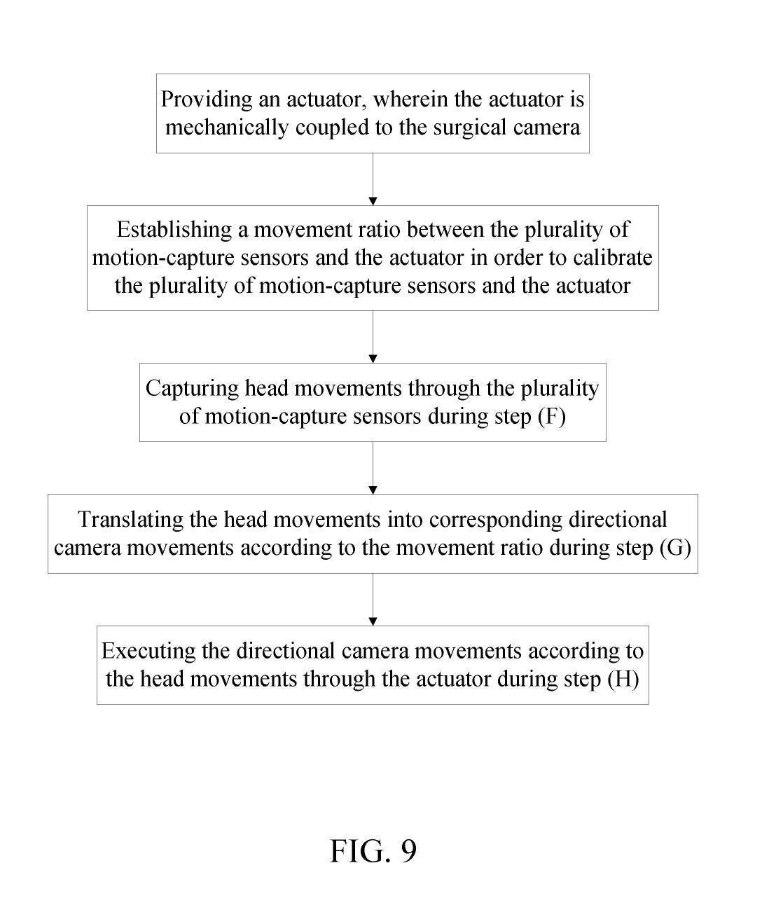

Another example of calibration is the degree to which the surgical camera is moved according to the head movements. As shown in FIG. 9, the user is able to establish a movement ratio between the plurality of motion-capture sensors and the actuator in order to calibrate the plurality of motion-capture sensors and the actuator. In this case, a large movement ratio may result in head movements producing a large amount of movement for the surgical camera. This is particularly suitable if the user wishes to move the surgical camera to a large degree with smaller head movements. Additionally, a large movement ratio allows the user to move the surgical camera without moving his or her head to a large degree. Conversely, a small movement ratio may result in head movements producing a small amount of movement for the surgical camera. A small movement ratio is suitable if the user wishes to move the surgical camera to a small degree, even with larger head movements. For example, if the surgical camera is in operation within a closed tight space, a small movement ratio is suitable as there is no need for large movements of the surgical camera. Head movements are captured through the plurality of motion-capture sensors and translated into corresponding directional camera movements according to the movement ratio. The directional camera movements based on the head movements are thus adjusted according to the movement ratio in order to achieve the desired movement of the surgical camera. The directional camera movements are then executed according to the head movements through the actuator. When the directional camera movements are executed after calibration, the surgical camera moves according to the head movements, following adjustment based on the movement ratio.

During use of the present invention, there may be demands of camera position that cannot be directly recreated through head movements due to limitations in physical movement. For example, in order to move the camera much closer to a target, the user is required to walk forward. This is not practical in an operating room setting. Movements in the x-axis and the y-axis may be direct or adjusted based on the movement ratio as previously discussed. However, movements in the z-axis may behave in a more binary manner. For example, when the head is moved slightly forward, the forward movement of the surgical camera is activated until the head is brought back to neutral with respect to the z-axis. In this case, the converse is also true for backward movements of the head.

Although the present invention has been explained in relation to its preferred embodiment, it is understood that many other possible modifications and variations can be made without departing from the spirit and scope of the present invention as hereinafter claimed.

What is claimed is:

1. A method for controlling a surgical camera through head movements, the method comprises the steps of:
(A) providing a wearable headpiece and a plurality of motion-capture sensors, wherein the plurality of motion-capture sensors is positioned about the wearable headpiece;
(B) providing a surgical camera, wherein the surgical camera is controlled by the plurality of motion-capture sensors;
(C) providing a gaze detection device;
(D) providing a left digital display and a right digital display for the wearable headpiece, wherein the left digital display and the right digital display are electronically connected to the surgical camera and wherein the left digital display and the right digital display are positioned on the wearable headpiece;
(E) outputting a live video feed from the surgical camera through the left digital display and the right digital display;
(F) capturing head movements through the plurality of motion-capture sensors,
if the gaze detection device detects an iris position to be oriented toward the left digital display and/or the right digital display;
(G) translating the head movements into corresponding directional camera movements;
(H) moving the surgical camera according to the directional camera movements;
(I) terminating capture of head movements and disabling movement of the surgical camera,
if the gaze detection device detects the iris position to be oriented away from the left digital display and/or the right digital display;

2. The method for controlling a surgical camera through head movements as claimed in claim 1, the method comprises the steps of:
providing an iris detection camera as the gaze detection device;
continuously monitoring the iris position through the iris detection camera;

3. The method for controlling a surgical camera through head movements as claimed in claim 1, the method comprises the steps of:
providing an actuator, wherein the actuator is mechanically coupled to the surgical camera;
moving the surgical camera according to the directional camera movements through the actuator;

4. The method for controlling a surgical camera through head movements as claimed in claim 1, the method comprises the steps of:
providing a microphone;
prompting to record a vocal disable command through the microphone;
receiving a vocal input through the microphone;
comparing the vocal input to the vocal disable command;
ceasing capture of head movements and disabling movement of the surgical camera,
if the vocal input is recognized as the vocal disable command;

5. The method for controlling a surgical camera through head movements as claimed in claim 1, the method comprises the steps of:
providing an actuator, wherein the actuator is mechanically coupled to the surgical camera;
providing a manual disable switch, wherein the manual disable switch is mechanically or electronically coupled to the actuator;
ceasing capture of head movements and disabling movement of the surgical camera,
if the manual disable switch is actuated;

6. The method for controlling a surgical camera through head movements as claimed in claim 1, the method comprises the steps of:
providing an actuator, wherein the actuator is mechanically coupled to the surgical camera;
providing a gaze detection device;
providing an actuator, wherein the actuator is mechanically coupled to the surgical camera;
calibrating the wearable headpiece, the plurality of motion-capture sensors, and the actuator;

7. The method for controlling a surgical camera through head movements as claimed in claim 6, the method comprises the steps of:
providing a plurality of light-emitting diodes (LEDs) for the wearable headpiece, wherein the gaze detection device is positioned adjacent to the plurality of LEDs;
providing a bottom peripheral edge for the left digital display and the right digital display, wherein the gaze detection device is positioned in between the bottom peripheral edge and the plurality of LEDs;
prompting to observe the bottom peripheral edge in order to calibrate the wearable headpiece;
receiving an iris sensor reading from the gaze detection device;
establishing a border for the gaze detection device at the bottom peripheral edge according to the iris sensor reading;

8. The method for controlling a surgical camera through head movements as claimed in claim 6, the method comprises the steps of:
providing a perimetric border for the left digital display and the right digital display, wherein the gaze detection device is positioned adjacent to the perimetric border;
prompting to observe the perimetric border in order to calibrate the wearable headpiece;
receiving an iris sensor reading from the gaze detection device;
establishing a border for the gaze detection device at the perimetric border according to the iris sensor reading;

9. The method for controlling a surgical camera through head movements as claimed in claim 6, the method comprises the steps of:
providing an actuator, wherein the actuator is mechanically coupled to the surgical camera;
establishing a movement ratio between the plurality of motion-capture sensors and the actuator in order to calibrate the plurality of motion-capture sensors and the actuator;
capturing head movements through the plurality of motion-capture sensors during step (F);
translating the head movements into corresponding directional camera movements according to the movement ratio during step (G);
executing the directional camera movements according to the head movements through the actuator during step (H);
